(19) United States
(12) Patent Application Publication
(10) Pub. No.: US 2014/0372146 A1
(43) Pub. Date: Dec. 18, 2014

(54) DETERMINING A PHYSIOLOGIC SEVERITY OF ILLNESS SCORE FOR PATIENTS ADMITTED TO AN ACUTE CARE FACILITY

(71) Applicant: CERNER INNOVATION, INC., Lenexa, KS (US)

(72) Inventor: ANDREW A. KRAMER, Leesburg, VA (US)

(21) Appl. No.: 13/916,140

(22) Filed: Jun. 12, 2013

(51) Int. Cl. G06F 19/00

(52) U.S. Cl. CPC G06F 19/3431
USPC 705/3

(57) ABSTRACT

Systems, methods, and computer storage media are provided for determining a physiologic severity of illness score (pSIS) for a patient admitted to an acute care healthcare facility. Data corresponding to physiologic components is received from an electronic medical record associated with a patient admitted to an acute care healthcare facility. The data is not required to correspond to physiologic components collected in or associated with an intensive care unit. Weights are assigned to each physiologic component. The weights are derived based on a deviation from normal. A physiologic severity of illness score (pSIS) is for the patient is determined by summing the weights. Additional data corresponding to the physiologic components may be received from the electronic medical record. The additional data may be utilized to update the weights and determine an updated pSIS for the patient which may be utilized to track a progress of the patient.

### BACKGROUND

Models for measuring severity of illness and predicting hospital mortality for patients in Intensive Care Units (ICUs) have been around for quite some time. This has come about not only as a result of the desire to assess ICU performance by comparing observed and predicted mortality but also, at least in part, due to the more recent ability to capture data electronically.

Large data sets containing numerous measurements on a wide variety of patients has enabled the development of sophisticated predictive models of mortality. Without exception, these predictive models involve a one-step process. That is, information on a set of variables is collected and fed into a single logistic regression equation. Two of the preeminent mortality prediction models for critically ill patients in the United States are the Acute Physiology and Chronic Health Evaluation (APACHE®) model and the Mortality Probability Model at Admission (MPM₀). Each of these mortality prediction models utilizes multiple variables in a single logistic regression equation to predict a patient's probability of mortality.

The APACHE® prediction methodology is based on the view that the core mission of intensive care is to treat disease and maintain physiological homeostasis. The central metric is the APACHE® score. It measures severity of illness during the first day after ICU admission, using the type and extent of acute physiological abnormality (the Acute Physiology Score or APS) and physiological reserve (age and co-morbid conditions). The APS is a sum of weights incurred by 17 physiologic parameters, the weights being determined by each physiologic measure's worst value within their first day in the ICU. It reflects a patient's response to treatment within the first ICU day. These components of the APACHE® score are used in the over 70 predictive equations that make up the APACHE® System. One such equation predicts mortality before hospital discharge. This equation contains 143 variables, including terms for the APS, age, seven comorbid conditions, the time between hospital admission and ICU admission, 116 diagnostic categories, the admission source, and five additional clinical variables. In summary, the APACHE® mortality prediction model collects information based primarily on physiologic parameters collected within the first day in the ICU, and supplemented by, among other things, specific information on diagnosis.

The MPM₀ mortality prediction model is a more simplistic model that utilizes information collected upon admission to the ICU or within one hour thereafter. It consists of 17 variables: 16 binary variables and the patient's age, as well as interaction terms between six of the binary variables and age. These variables were chosen to characterize a patient's acuity at the time of ICU admission, before being appreciably affected by ICU care. The MPM₀ model is a much smaller model than the APACHE® mortality prediction model, is based on information collected at or within the first hour post-admission, and expresses a patient's clinical condition upon admission.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In various embodiments, methods, systems, and computer storage media are performing a method in a clinical computing environment for determining a physiologic severity of illness score (pSIS) for patients admitted to an acute care healthcare facility. Data corresponding to physiologic components is received from an electronic medical record associated with a patient admitted to an acute care healthcare facility. The data is not required to correspond to physiologic components collected in or associated with an intensive care unit. Weights are assigned to each physiologic component. The weights are derived based on a deviation from normal. A physiologic severity of illness score (pSIS) is for the patient is determined by summing the weights. Additional data corresponding to the physiologic components may be received from the electronic medical record. The additional data may be utilized to update the weights and determine an updated pSIS for the patient which may be utilized to track a progress of the patient.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system for determining a pSIS for a patient admitted to an acute care healthcare facility, in accordance with various embodiments of the present invention;

FIG. 3 is a flow diagram showing an exemplary method for determining a pSIS for a patient admitted to an acute care healthcare facility, in accordance with various embodiments of the present invention; and

FIG. 4 is a flow diagram showing an exemplary method for determining a pSIS for a patient admitted to an acute care healthcare facility, in accordance with various embodiments of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Predictive scoring models are used to estimate the probability of a specific outcome, such as mortality. These models are primarily based on administrative data culled from medical claims forms and thus are of limited accuracy. Existing predictive scoring models that use electronic medical record data are available only for patients admitted to ICUs (based on physiologic parameters collected within the first day in the ICU).

As previously set forth, in various embodiments, methods, systems, and computer storage media are provided for determining a physiologic a severity of illness score (pSIS) for a patient admitted to an acute care healthcare facility. Data corresponding to physiologic components is received from an electronic medical record associated with a patient admitted to an acute care healthcare facility. The data is not required to correspond to physiologic components collected in or associated with an intensive care unit. Weights are assigned to each physiologic component. The weights are derived based on a deviation from normal. A physiologic severity of illness score (pSIS) is for the patient is determined by summing the weights. Additional data corresponding to the physiologic components may be received from the electronic medical record. The additional data may be utilized to update the weights and determine an updated pSIS for the patient which may be utilized to track a progress of the patient.

Accordingly, one embodiment of the present invention is directed to one or more computer hardware storage media having computer-executable instructions embodied thereon that, when executed by a computing device, cause the computing device to perform a method for determining a physiologic a severity of illness score (pSIS) for a patient admitted to an acute care healthcare facility. The method comprises: receiving data corresponding to physiologic components from an electronic medical record associated with a patient admitted to an acute care healthcare facility, the data associated with common laboratory tests on a blood sample taken from the patient and not derived from administrative data, the data not required to correspond to physiologic components collected in or associated with an intensive care unit; assigning weights to each physiologic component, the weights derived based on a deviation from normal; determining a pSIS for the patient by summing the weights; receiving additional data corresponding to the physiologic components from the electronic medical record; and utilizing the additional data to update the weights and determine an updated pSIS for the patient.

Another embodiment of the present invention includes a computer system for determining a physiologic severity of illness score (pSIS) for a patient admitted to an acute care healthcare facility. The computer system comprises one or more processors coupled to a computer storage medium, the computer storage medium having stored thereon a plurality of computer software components executable by the one or more processors. The computer software components comprise: a receiving component that is configured to receive data corresponding to physiologic components from an electronic medical record associated with a patient admitted to an acute care facility, the data associated with common laboratory tests on a blood sample taken from the patient; a determining component that is configured to determine a physiologic severity of illness score (pSIS) for the patient by summing weights associated with each physiologic component, the pSIS not limited to the patient being admitted to an intensive care unit (ICU); an additional data component that is configured to receive additional data corresponding to the physiologic components from the electronic medical record; an update component that is configured to update the weights and determine an updated pSIS for the patient; and a tracking component that is configured to notify a clinician of a progress associated with the patient based on the updated pSIS.

Yet another embodiment of the present invention is directed to a method for determining a physiologic severity of illness score (pSIS) for a patient admitted to an acute care healthcare facility. The method comprises: analyzing data associated with a group of patients associated with an acute care facility; identifying outcomes associated with the group of patients; associating the outcomes with trends for the group of patients; identifying predictive variables corresponding to physiologic components associated with the trends; assigning predictive weights to the predictive variables based on deviation from normal; utilizing the predictive variables and the predictive weights to determine a pSIS utilized for patients belonging to a similar group as the group of patients, without requiring any data corresponding to physiologic components being collected in or associated with an intensive care unit.

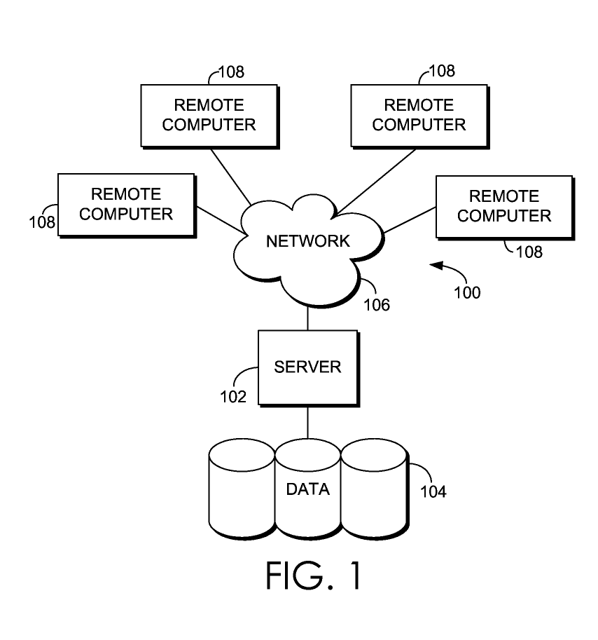

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 10 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with embodiments of the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a control server 102. Components of the control server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the receipt and processing of healthcare orders. As contemplated by the language above, the methods and systems of embodiments of the present invention may also be implemented on a stand-alone desktop, personal computer, or any other computing device used in a healthcare environment or any of a number of other locations.

As previously mentioned, embodiments of the present invention relate to methods, systems, and computer storage media for use in, e.g., a healthcare computing environment, for determining a physiologic a severity of illness score (pSIS) for a patient admitted to an acute care healthcare facility. Data corresponding to physiologic components is received from an electronic medical record associated with a patient admitted to an acute care healthcare facility. The data is not required to correspond to physiologic components collected in or associated with an intensive care unit. Weights are assigned to each physiologic component. The weights are derived based on a deviation from normal. A physiologic severity of illness score (pSIS) is for the patient is determined by summing the weights. Additional data corresponding to the physiologic components may be received from the electronic medical record. The additional data may be utilized to update the weights and determine an updated pSIS for the patient which may be utilized to track a progress of the patient.

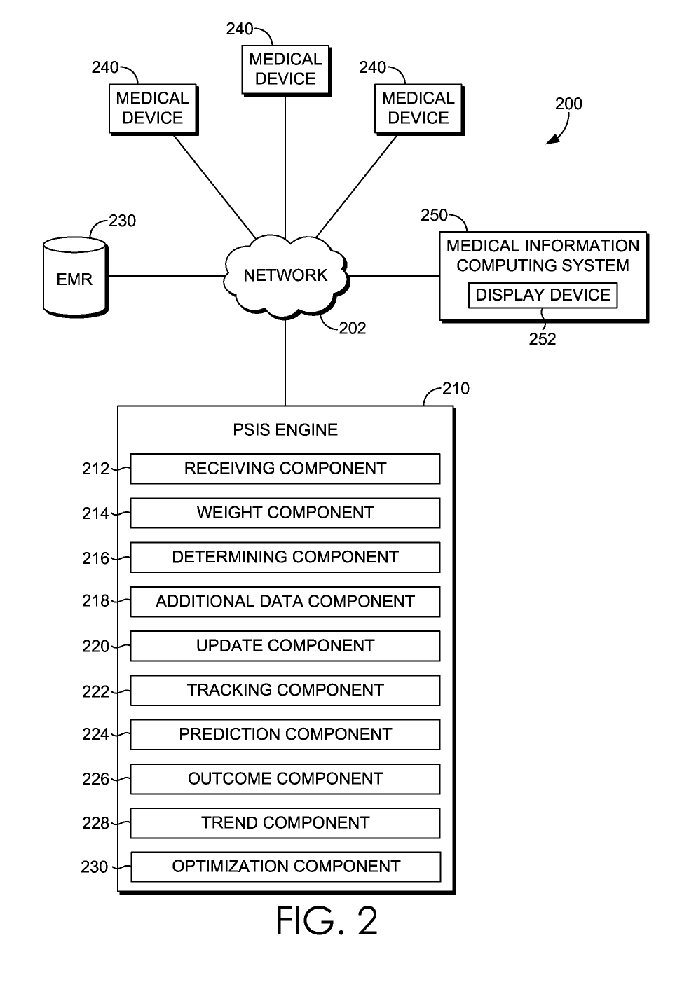

Referring now to FIG. 2, a block diagram is provided illustrating an exemplary system 200 in which a PSIS engine 210 is shown interfaced with a medical information computing system 250 in accordance with an embodiment of the present invention. The medical information computing system 250 may be a comprehensive computing system within a clinical environment similar to the exemplary computing system 100 discussed above with reference to FIG. 1.

The medical information computing system 250 includes a clinical display device 252. In one embodiment, the clinical display device 252 is configured to display a PSIS score as determined by PSIS engine 210. In another embodiment, the clinical display device is configured to receive input from the clinician, such as selection of a patient type, unit, facility information, or information associated with the patient, and the like. In another embodiment, the medical information computing system 250 receives input, such as information associated with a patient, from one or more medical devices 240.

The PSIS engine 210 is generally configured to determine a PSIS for a patient admitted to an acute care facility. As shown in FIG. 2, the PSIS engine 210 includes, in various embodiments, a receiving component 212, a weight component 214, a determining component 216, a prediction component 218, an update component 220, a tracking component 222, a prediction component 224, an outcome component 226, a trend component 228, and an optimization component 230.

Receiving component 212 is configured to receive data corresponding to physiologic components from an electronic medical record associated with a patient admitted to an acute care facility. The data is associated with common laboratory tests on a blood sample taken from the patient. This eliminates the need to measure arterial blood gas components and urine output that is common to existing predictive scoring models that are limited to the ICU. Also eliminated is vital signs information as well as Glasgow coma score. Further, the data is not required to correspond to physiologic components collected in or associated with an ICU. In other words, the data is available for the general patient population in an acute care facility and there is no need for the patient to be in an ICU or the data taken within the first day of admission to the ICU for the data to be usable by the PSIS engine 210 to determine the PSIS.

In one embodiment, weight component 214 is configured to assign weights to each physiologic component or measure of interest. The weights are derived based on a deviation from normal. A classification and regression tree (CART) methodology is utilized, in one embodiment, to assign weights to the physiologic measure of interest. Initially a weight is set to 0. The CART algorithm consecutively makes a split on the physiologic measure of interest when the result yields a significant difference in the outcome. For example, if heart rate is the physiologic measure of interest, the CART algorithm might make a first split at heart rate<50 vs. heart rate≧50 because mortality in the former was identified in twenty-five percent of the observations and in the later was identified in two percent of the observations. Further splits are made to arrive at endpoints that are maximally homogenous. This approach yields the cut-points that define the physiologic ranges. A cost function may be added that weights the splits in terms of node purity (e.g., the splits with the greatest purity have the greatest cost).

For example, platelet count is a measurement not included by the APACHE® methodology. Thus, a set of cut-points and ranges is developed as follows. A CART algorithm is run by weight component 214 which identifies only two splits: at platelet count<100 and at platelet count>380. The relative cost associated with each of these splits is 8 and 3, respectively.

In one embodiment, thirteen physiologic measures of interest include eight items included by the APACHE® methodology (Albumin, Blood Urea Nitrogen (BUN), Bilirubin, Creatinine, Glucose, Hematocrit, Sodium, and White Blood Cell Count) as well as five items not included by APACHE (Aspartate Transaminase (AST), International Normalized Ratio (INR), Platelet Count, Potassium, and Troponin I). Each of these thirteen physiologic measures of interest are all available via common laboratory tests on a blood sample, eliminating the need (i.e., as required by the APACHE® methodology) to measure arterial blood gas components and urine output.

In one embodiment, the eight physiologic measure of interest included by the APACHE® methodology are utilized with the same cut-points (in parenthesis) and weights (before parenthesis) as utilized by the APACHE® methodology and shown below in Table 1.

TABLE 1

| | | | | | | |
|---|---|---|---|---|---|---|
| 11 (≦1.9) | 6 (2.0-2.4) | Albumin 0 | 4 (≧4.5) | | | |
| | | (2.5-4.4 g/dL) | | | | |
| | | Bilirubin 0 | 5 (2.0-2.9) | 6 (3.0-4.9) | 8 (5.0-7.9) | 16 (≧8.0) |
| | | (≦1.0 mg/dL) | | | | |
| | | BUN 0 (≦16.9) | 2 (17-19) | 7 (20-39) | 11 (40-79) | 12 (≧80) |
| | 3 (≦0.49) | Creatinine 0 | 4 (1.50-1.94) | 7 (≦1.95) | | |
| | | (0.5-1.4 mg/dL) | | | | |
| | 8 (≦59) | Glucose 0 | 3 (200-349) | 4 (≧350) | | |
| | | (60-199 mg/dL) | | | | |
| | 3 (≦40.9) | Hematocrit 0 | 3 (≧50) | | | |
| | | (41-49%) | | | | |
| 3 (≦119) | 2 (120-134) | Sodium 0 | 4 (≦155) | | | |
| | | (135-154 mmol/L) | | | | |
| 19 (≦1.0) | 5 (1.0-2.9) | White Blood Cells 0 | 1 (20.0-24.9) | 5 (≧25.0) | | |
| | | (3.0-19.9 cu/mm) | | | | |

In one embodiment, five new physiologic measures of interests utilize cut-points (in parenthesis) and weights (before parenthesis) as shown below in Table 2.

TABLE 2

| | | | | |
|---|---|---|---|---|
| | AST 0 | 2 (≧36) | 4 (≧60) | 13 (≧100) |
| | (≦35 IU/L) | | | |
| | INR 0 | 2 (3.0-5.1) | 9 (>5.2) | |
| | (≦3.0 Ratio of | | | |
| | Prothorombin | | | |
| | Time) | | | |
| 8 (<100) | Platelet Count 0 | 3 (>380) | | |
| | (100-380 | | | |
| | 1,000/μL) | | | |
| 5 (≦3.10) | Potassium 0 | 4 (5.11-6.00) | 9 (≧6.01) | |
| | (3.11-5.10 | | | |
| | mmol/L) | | | |
| | Troponin I 0 | 4 (3.3-12.4) | 6 (>12.5) | |
| | (≦3.2 ng/mL) | | | |

Determining component 216 is configured to determine a physiologic severity of illness score (pSIS) for the patient by summing weights associated with each physiologic component or measure of interest for data received by receiving component 212 with as weight assigned by weight component 214. Because the data is not required to correspond to physiologic components collected in or associated with an ICU, the pSIS is not limited to the patient being admitted to the ICU. Thus, the pSIS can be determined by the determining component 216 for the general patient population within an acute care facility.

Additional data component 218 is configured to receive additional data corresponding to the physiologic components from the electronic medical record. The additional data may be based on changes associated with the patient that might affect the weight for a particular physiologic component and/or the pSIS. The additional data may be based on a clinician's desire to monitor a particular physiologic component or a follow-up measurement for that physiologic component. Similarly, the additional data may be based on a follow-up visit or later admission (i.e., after the initial admission) to the acute care facility.

Update component 220 is configured to update the weights and determine an updated pSIS for the patient. In one embodiment, update component 220 assigns updated weights to each physiologic component. In another embodiment, the update component 220 may communicate the additional data corresponding to the physiologic components to weight component 214 so weight component 214 can assign updated weights to each physiologic component. In one embodiment, weight component 214 communicates the updated weights to determining component 216 to determine the updated pSIS. In another embodiment, update component 220 the updated pSIS.

In one embodiment, tracking component 222 is configured to notify a clinician of a progress associate with the patient based on the updated pSIS. In one embodiment, tracking component 222 tracks, over time, a PSIS associated with the patient to gauge the patient's overall health status. In one embodiment, the PSIS may also be tracked over time and used in analytics, tracking patient progress, billing, reimbursement, scheduling staff, and patient acuity. In one embodiment, prediction component 224 utilizes the PSIS in a predictive equation to predict one of a length of stay for the patient, a location of stay for the patient, a 30-day readmission risk at discharge for the patient, a discharge destination for the patient, or hospital mortality.

In one embodiment, outcome component 226 analyzes data associated with a group of patients and identifies outcomes associated with the group of patients. The outcomes may be length of stay, location of stay, readmission risk, discharge destination, or hospital mortality. In one embodiment, trend component 228 is configured to associate the outcomes with trends for the group of patients. The trends may be individualized for the acute care facility or for a category of patients associated with the acute care facility. The trends may indicate certain physiologic measure of interest have a high value to the facility or category of patients.

These trends may allow the PSIS engine 210 to be optimized by optimization component 230. In one embodiment, optimization component 230 is configured to identify additional physiologic components based on trends associated with the data to include by the determining component for determining the pSIS. Once identified, physiologic components utilized to determine the pSIS may be updated and data received by receiving component 212 may include these new components or remove components that do not add value to the particular outcome or trend. Similarly, weight component 213 may be configured to assign weights to the updated physiologic components in a similar manner as described above.

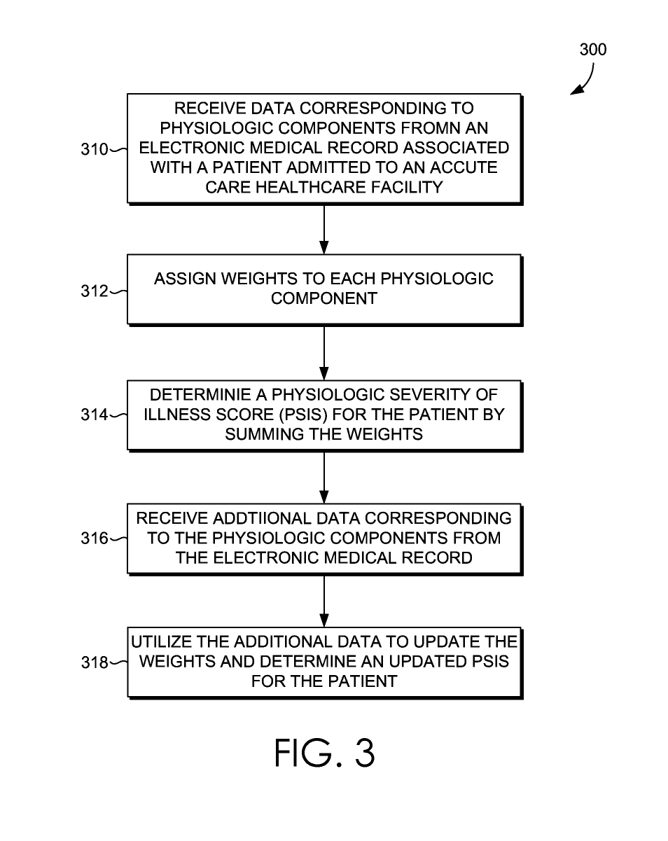

Turning now to FIG. 3, a flow diagram is provided illustrating a method 300 for determining a pSIS for a patient admitted to an acute care healthcare facility, in accordance with various embodiments of the present invention. Initially, as shown at step 310, data corresponding to physiologic components is received from an electronic medical record associated with a patient admitted to an acute care healthcare facility. The data is associated with common laboratory tests on a blood sample taken from the patient and is not derived from administrative data. Further, the data is not required to correspond to physiologic components collected in or associated with an intensive care unit.

Weights, at step 312, are assigned to each physiologic component. The weights are derived based on a deviation from normal. A classification and regression tree (CART) methodology may be utilized, as described above, to assign weights to the physiologic measure of interest.

At step 314, a pSIS is determined for the patient by summing the weights. In one embodiment, the pSIS can be utilized as a component or variable in predictive equations. Accordingly, in one embodiment, the pSIS can be utilized in a predictive equation to predict hospital mortality for the patient. In another embodiment, the pSIS can be utilized in a predictive equation to predict, at discharge, a 30-day readmission risk for the patient. In another embodiment, the pSIS can be utilized in a predictive equation to predict a discharge destination for the patient.

Additional data corresponding to the physiologic components is received, at step 316, from the electronic medical record. The additional data is utilized to update the weights and determine an updated pSIS for the patient at step 318. In one embodiment, a progress of the patient is tracked based on the updated pSIS. For example, a clinician can compare the initial pSIS to subsequent updated pSIS's to determine whether a treatment is working or the patient is progressing appropriately.

In one embodiment, data associated with a group of patients associated with the facility or unit is analyzed. Outcomes associated with the group of patients may be identified. The outcomes may be associated with trends for the group of patients. In one embodiment, the trends are individualized according to a facility. In one embodiment, the trends are individualized according to a category of patient associated with the facility. Predictive variables associated with the trends may be identified. Predictive weights can be assigned to the predictive variables based on deviation from normal in a similar manner described above. In one embodiment, the predictive variables and the predictive weights to may be utilized to update the physiologic components and weights utilized to determine the pSIS for future patients belonging to a similar group as the group of patients.

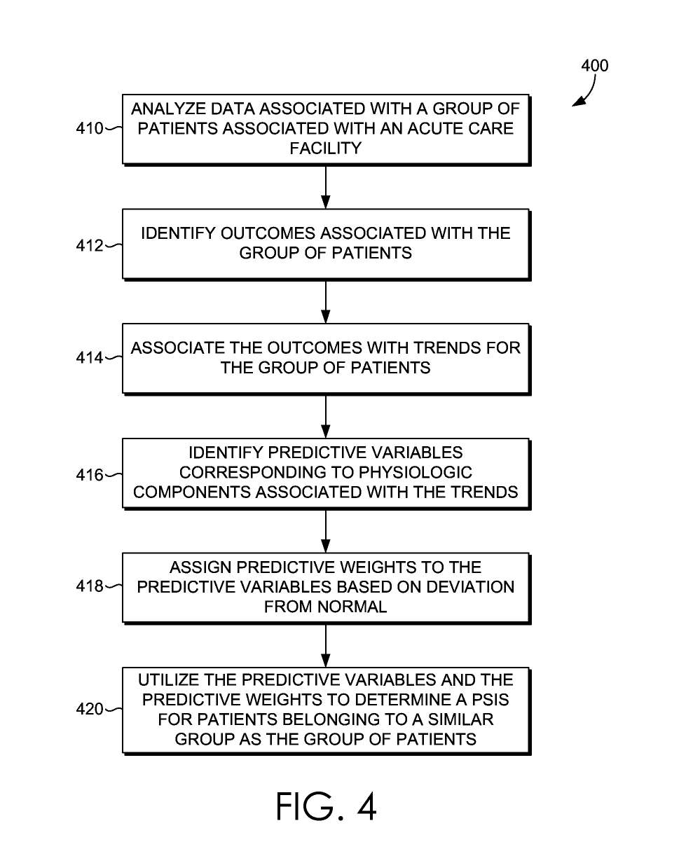

Turning now to FIG. 4, a flow diagram is provided illustrating a method 400 for determining a pSIS for a patient admitted to an acute care healthcare facility, in accordance with various embodiments of the present invention. Initially, at step 410, data associated with a group of patients associated with an acute care facility is analyzed. Outcomes associated with the group of patients are identified at step 412. The outcomes, at step 414, are associated with trends for the group of patients. Predictive variables corresponding to physiologic components associated with the trends are identified at step 416. At step 418, predictive weights are assigned, such as in the manner described above, to the predictive variables based on deviation from normal. The predictive variables and the predictive weights are utilized, at step 420, to determine a pSIS utilized for patients belonging to a similar group as the group of patients. No data corresponding to physiologic components is required to be collected in or associated with an intensive care unit. In other words, the pSIS can be determined for the general patient population, regardless of whether the patient is in the ICU or not, within an acute care facility.

As can be understood, embodiments of the present invention provide computerized methods and systems for use in, e.g., a healthcare computing environment, for determining a pSIS for a patient admitted to an acute care facility. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

What is claimed is:

1. One or more computer hardware storage media having computer-executable instructions embodied thereon that, when executed by a computing device, cause the computing device to perform a method for determining a physiologic severity of illness score (pSIS) for a patient admitted to an acute care healthcare facility, the method comprising:
receiving data corresponding to physiologic components from an electronic medical record associated with a patient admitted to an acute care healthcare facility, the data associated with common laboratory tests on a blood sample taken from the patient and not derived from administrative data, the data not required to correspond to physiologic components collected in or associated with an intensive care unit;
assigning weights to each physiologic component, the weights derived based on a deviation from normal;
determining a pSIS for the patient by summing the weights;
receiving additional data corresponding to the physiologic components from the electronic medical record; and
utilizing the additional data to update the weights and determine an updated pSIS for the patient.

2. The media of claim 1, further comprising analyzing data associated with a group of patients associated with the facility or unit.

3. The media of claim 2, further comprising identifying outcomes associated with the group of patients.

4. The media of claim 3, further comprising associating the outcomes with trends for the group of patients.

5. The media of claim 4, wherein the trends are individualized according to a facility.

6. The media of claim 4, wherein the trends are individualized according to a category of patient associated with the facility.

7. The media of claim 4, identifying predictive variables associated with the trends.

8. The media of claim 7, further comprising assigning predictive weights to the predictive variables based on deviation from normal.

9. The media of claim 8, utilizing the predictive variables and the predictive weights to update the pSIS utilized for future patients belonging to a similar group as the group of patients.

10. The media of claim 1, further comprising tracking a progress of the patient based on the updated pSIS.

11. The media of claim 1, further comprising utilizing the pSIS in a predictive equation to predict hospital mortality for the patient.

12. The media of claim 1, further comprising utilizing the pSIS in a predictive equation to predict, at discharge, a 30-day readmission risk for the patient.

13. The media of claim 1, further comprising utilizing the pSIS in a predictive equation to predict a discharge destination for the patient.

14. A computer system for determining a physiologic severity of illness score (pSIS) for a patient admitted to an acute care healthcare facility, the computer system comprising one or more processors coupled to a computer storage medium, the computer storage medium having stored thereon a plurality of computer software components executable by the one or more processors, the computer software components comprising:
a receiving component that is configured to receive data corresponding to physiologic components from an electronic medical record associated with a patient admitted to an acute care facility, the data associated with common laboratory tests on a blood sample taken from the patient;
a determining component that is configured to determine a physiologic severity of illness score (pSIS) for the patient by summing weights associated with each physiologic component, the pSIS not limited to the patient being admitted to an intensive care unit (ICU);
an additional data component that is configured to receive additional data corresponding to the physiologic components from the electronic medical record;
an update component that is configured to update the weights and determine an updated pSIS for the patient; and
a tracking component that is configured to notify a clinician of a progress associated with the patient based on the updated pSIS.

15. The computer system of claim 14, further comprising a weight component that is configured to assign weights to each physiologic component, the weights derived based on a deviation from normal.

16. The computer system of claim 15, further comprising a prediction component that is configured to utilize the pSIS to predict one of a length of stay for the patient, a location of stay for the patient, a 30-day readmission risk at discharge for the patient, a discharge destination for the patient, or hospital mortality.

17. The computer system of claim 15, further comprising an outcome component that analyzes data associated with a group of patients and identifies outcomes associated with the group of patients.

18. The computer system of claim 17, further comprising a trend component that is configured to associate the outcomes with trends for the group of patients, the trends being individualized for the acute care facility or a category of patients associated within the acute care facility.

19. The computer system of claim 17, further comprising an optimization component that is configured to identify additional physiologic components based on trends associated with the data to include by the determining component for determining the pSIS.

20. A method for determining a physiologic severity of illness score (pSIS) for a patient admitted to an acute care healthcare facility, the method comprising;
analyzing data associated with a group of patients associated with an acute care facility;
identifying outcomes associated with the group of patients;
associating the outcomes with trends for the group of patients;
identifying predictive variables corresponding to physiologic components associated with the trends;
assigning predictive weights to the predictive variables based on deviation from normal;
utilizing the predictive variables and the predictive weights to determine a pSIS utilized for patients belonging to a similar group as the group of patients, without requiring any data corresponding to physiologic components being collected in or associated with an intensive care unit.
